(19) United States
(12) Patent Application Publication
(10) Pub. No.: US 2026/0287140 A1
(43) Pub. Date: Sep. 24, 2026

(54) Apparatus for defrosting a vehicle light

(71) Applicant: AAC Enterprises LLC, dba Oracle Lighting, Metairie, LA (US)

(72) Inventor: Justin HARTENSTEIN, Metairie, LA (US)

(73) Assignee: AAC Enterprises LLC, dba Oracle Lighting, Metairie, LA (US)

(21) Appl. No.: 19/645,409

(22) Filed: Apr. 13, 2026

Related U.S. Application Data
(63) Continuation-in-part of application No. 17/645,807, filed on Dec. 23, 2021, now Pat. No. 12,618,541.
(60) Provisional application No. 63/135,852, filed on Jan. 11, 2021.

(51) Int. Cl. F21S 45/60; B60Q 1/04; B60S 1/02; H05B 3/84

(52) U.S. Cl. CPC F21S 45/60; B60S 1/026; H05B 3/84; B60Q 1/04

(57) ABSTRACT

A layered apparatus for defrosting a vehicle light includes a heating element, a cover, and an attachment mechanism. The heating element has a heating element external surface and a heating element internal surface. The cover has a cover external surface and a cover internal surface. The heating element and the cover are coplanar and the attachment mechanism is configured to attach the heating element and the cover to the vehicle light. The layered apparatus may further include an insulant. When present, the insulant has an insulant external surface, and an insulant internal surface. Additionally when present, the insulant is coplanar with the heating element and the cover. The layered apparatus may further include a top. When present, the top has a top external surface, and a top internal surface. Additionally when present, the top is coplanar with the heating element, the cover, and when present, the insulant.

### CROSS REFERENCES AND PRIORITIES

This Application claims priority from U.S. Provisional Application No. 63/135,852 filed on 11 Jan. 2021 and U.S. Nonprovisional application No. Ser. No. 17/645,807 filed on 23 Dec. 2021, the teachings of each of which are incorporated by reference herein in their entirety.

### BACKGROUND

Frost, ice, snow, and moisture on or within a vehicle lighting assembly poses a particular problem for vehicle drivers—especially those living in cold-weather climates. For example, frost, ice, and snow buildup on top of or inside the lens of a headlight can be particularly dangerous as it can block or diffuse light emitted from the headlight resulting in the vehicle driver having difficulty seeing the road in front of them at night.

A number of solutions are commonly used in vehicles for removing frost, ice, snow, and moisture. The simplest of these apply to the vehicle's front and rear windshields, and commonly involve the use of a forced air heater which applies hot air to an interior surface of the window (typically seen for vehicle front windshields) or a series of heating elements applied to or embedded in the window (typically seen for vehicle rear windshields).

Solutions for removing frost, ice, snow, and moisture from a vehicle lighting assembly have also been proposed. The most common solution involves the placement of heating wires or other heating elements onto or embedded in the lighting assembly housing. One such solution is proposed in United States Patent Publication No. 2018/0245767 which discloses a headlight equipped with heating wires, which is implemented such that transparent heating wires are disposed in the plastic of the headlight and the plastic of the headlight is heated through the generation of heat by the heating wires.

Such prior art solutions may be useful for new vehicles where they can be included in the original lighting assembly. However, such solutions are impractical for existing vehicles which do not include an existing solution for removing frost, ice, snow, and moisture from the lighting assemblies. As the heating elements are integral components of the lighting assembly, these solutions require complete replacement of the lighting assembly, which is often an expensive and labor-intensive task.

The need exists, therefore, for an improved solution for removing frost, ice, snow, and moisture from a vehicle lighting assembly which can be retrofit to existing vehicle lighting assemblies.

### SUMMARY

Described herein is an apparatus for defrosting a vehicle light. The apparatus may comprise a frame, a heating element, an attachment mechanism, and an electrical communication connection. The frame will have an external facing surface and an internal facing surface. The heating element may be connected to at least a portion of the internal facing surface of the frame. The electrical communication connection may be electrically connected between the heating element and a power source.

The apparatus may be configured to connect to an exterior surface of a vehicle or a vehicle light lens. The attachment mechanism may be selected from the group consisting of at least one mounting bracket, a plurality of protrusions adapted to provide a friction fit with a surface of the vehicle, an adhesive, a fastener, a set screw, and combinations thereof.

In some embodiments, the apparatus may further comprise a temperature sensor. The temperature sensor may be electrically connected to the power source. In certain embodiments, the temperature sensor may be connected to at least a portion of the external facing surface of the frame.

In certain embodiments, the frame may comprise the heating element in the form of a conductive tube type heater. In other embodiments, the heating element may be selected from the group consisting of a ceramic heating element, a resistance wire, a conductive heating strip, and a screen-printed conductive silver plate.

In some embodiments, the frame may comprise at least one cross member. In some such embodiments, the heating element may be connected to at least a portion of at least one of the cross members.

In certain embodiments, the apparatus may be configured to connect to the exterior surface of the vehicle or vehicle light lens such that a gap exists between the internal facing surface of the frame and at least a portion of a vehicle light lens when the apparatus is connected to the vehicle. In some such embodiments, the gap may have a gap distance measurement in the range of between 0.1 cm and 12 cm. In other embodiments, the apparatus may be configured to connect to the exterior surface of the vehicle or vehicle light lens such that at least a portion of the internal facing surface of the frame is in direct contact with at least a portion of the vehicle light lens.

Further disclosed is a layered apparatus for defrosting a vehicle light including a heating element, a cover, and an attachment mechanism. The heating element has a heating element external surface and a heating element internal surface. The cover has a cover external surface and a cover internal surface. The heating element and the cover are coplanar and the attachment mechanism is configured to attach the heating element and the cover to the vehicle light.

In some further embodiments, the layered apparatus may further include an insulant. When present, the insulant has an insulant external surface, and an insulant internal surface. Additionally when present, the insulant is coplanar with the heating element and the cover.

In some further embodiments, the layered apparatus may further include a top. When present, the top has a top external surface, and a top internal surface. Additionally when present, the top is coplanar with the heating element, the cover, and when present, the insulant.

In some further embodiments, the heating element internal surface is attached to the attachment mechanism and the heating element external surface is attached to the cover internal surface. Additionally, the cover external surface may be attached to the top internal surface.

In some further embodiments, the insulant internal surface is attached to the attachment mechanism, the insulant external surface is attached to the heating element internal surface, and the heating element external surface is attached to the cover internal surface. Additionally, the cover external surface may be attached to the top internal surface.

In some further embodiments, the heating element is attached to the cover by an attachment method selected from a group consisting of adhering, mechanical fastening, embedding, and integrating.

In some further embodiments, the heating element external surface is attached to the cover internal surface and the insulant external surface is attached to the heating element internal surface each by an attachment method selected from a group consisting of adhering, mechanical fastening, embedding. Additionally, the top internal surface is attached to the cover external surface each by an attachment method selected from a group consisting of adhering, mechanical fastening, embedding.

In some further embodiments, the attachment mechanism is an adhesive layer having an adhesive layer external surface and an adhesive layer internal surface The adhesive layer internal surface is configured to adhere to a vehicle lens of the vehicle light.

In some further embodiments, the attachment mechanism is a fastener selected from a group consisting of an adhesive, a bolt, a screw, a rivet, a strap, a nail, a pin, a clip, and a snap. Additionally, the attachment mechanism may be a plurality of clips arranged about an layered apparatus perimeter.

In some further embodiments, the attachment mechanism has a light transmission of at least 70%. Additionally, the heating element has a light transmission of at least 70%. Further, the cover has a light transmission of at least 70%.

In some further embodiments, the heating element is selected from a group consisting of a conductive mesh, a fine metal grid, a printed conductive ink, a plurality of silver nanowires, a graphene, a carbon-based material, a conductive coating, a conductive polymer, a vapor-deposited metal, a sputtered metal, a plurality of etched conductive traces, a thin resistive wire pattern, and any combination thereof.

In some further embodiments, when the attachment mechanism is an adhesive layer, the adhesive layer includes an adhesive selected from a group consisting of a pressure sensitive adhesive, an optical-grade adhesive, a thermally conductive adhesive, a removeable adhesive, a permanent adhesive, a repositionable adhesive, and any combination thereof.

### BRIEF DESCRIPTION OF FIGURES

FIG. 1 is an exploded perspective view of one embodiment of an apparatus for defrosting a vehicle light.

FIG. 2 is an assembled side cross section view of an embodiment of an apparatus for defrosting a vehicle light.

FIG. 3 is an assembled perspective view of the apparatus of FIG. 1.

FIG. 4 is a perspective view of an embodiment of an apparatus for defrosting a vehicle light installed on a vehicle.

FIG. 5A is a front view of one embodiment of cross members in an apparatus for defrosting a vehicle light.

FIG. 5B is a front view of another embodiment of cross members in an apparatus for defrosting a vehicle light.

FIG. 5C is a front view of another embodiment of cross members in an apparatus for defrosting a vehicle light.

FIG. 5D is a front view of another embodiment of cross members in an apparatus for defrosting a vehicle light.

FIG. 5E is a front view of another embodiment of cross members in an apparatus for defrosting a vehicle light.

FIG. 5F is a front view of another embodiment of cross members in an apparatus for defrosting a vehicle light.

FIG. 5G is a front view of another embodiment of cross members in an apparatus for defrosting a vehicle light.

FIG. 5H is a front view of another embodiment of cross members in an apparatus for defrosting a vehicle light.

FIG. 5I is a front view of another embodiment of cross members in an apparatus for defrosting a vehicle light.

FIG. 5J is a front view of another embodiment of cross members in an apparatus for defrosting a vehicle light.

FIG. 5K is a front view of another embodiment of cross members in an apparatus for defrosting a vehicle light.

FIG. 5L is a front view of another embodiment of cross members in an apparatus for defrosting a vehicle light.

FIG. 5M is a front view of another embodiment of cross members in an apparatus for defrosting a vehicle light.

FIG. 5N is a front view of another embodiment of cross members in an apparatus for defrosting a vehicle light.

FIG. 5O is a front view of another embodiment of cross members in an apparatus for defrosting a vehicle light.

FIG. 6 is an assembled view of a layered apparatus for defrosting a vehicle light assembled on a vehicle light lens.

FIG. 7A is an assembled view of an embodiment of a layered apparatus for defrosting a vehicle light exploded from a vehicle light.

FIG. 7B is an assembled view of another embodiment of a layered apparatus for defrosting a vehicle light exploded from a vehicle light.

FIG. 8 is an exploded view of a layered apparatus for defrosting a vehicle light exploded from a vehicle light.

FIG. 9A is a cross-section view of a layered apparatus for defrosting a vehicle light assembled on a vehicle light.

FIG. 9B is a close-up view of a layered apparatus for defrosting a vehicle light assembled on a vehicle light FIG. 10 is a front view of a vehicle with a layered apparatus for defrosting a vehicle light installed on a vehicle.

### DETAILED DESCRIPTION

Disclosed herein is an apparatus for defrosting a vehicle light. The apparatus is described below with reference to the Figures. As described herein and in the claims, the following numbers refer to the following structures as noted in the Figures.
10 refers to an apparatus.
10A refers to a first apparatus.
10B refers to a second apparatus.
20 refers to a layered apparatus.
20A refers to a first layered apparatus.
20B refers to a second layered apparatus.
21 refers to a layered apparatus external surface.
22 refers to a layered apparatus internal surface.
23 refers to a layered apparatus perimeter.
50 refers to a vehicle.
52 refers to a vehicle light.
52A refers to a left vehicle headlight.
52B refers to a right vehicle headlight
54 refers to a vehicle light lens.
54A refers to a vehicle light lens perimeter.
56 refers to a gap distance measurement.
100 refers to a frame.
101 refers to a first point (on the internal perimeter of the frame).
102 refers to a second point (on the internal perimeter of the frame).
103 refers to a third point (on the internal perimeter of the frame).
104 refers to a fourth point (on the internal perimeter of the frame).
105 refers to a fifth point (on the internal perimeter of the frame).
106 refers to a sixth point (on the internal perimeter of the frame).
107 refers to a seventh point (on the internal perimeter of the frame).
108 refers to an eighth point (on the internal perimeter of the frame).
110 refers to an external facing surface.
120 refers to an internal facing surface.
130 refers to a cross member.
130A refers to a first cross member.
130B refers to a second cross member.
130C refers to a third cross member.
130D refers to a fourth cross member.
200 refers to a heating element.
210 refers to a heating element external surface.
220 refers to a heating element internal surface.
300 refers to a mounting bracket.
400 refers to an electrical communication connection.
500 refers to a temperature sensor.
600 refers to an attachment mechanism.
610 refers to an adhesive layer external surface.
620 refers to an adhesive layer internal surface.
630 refers to an adhesive layer perimeter.
700 refers to an insulant.
710 refers to an insulant external surface.
720 refers to an insulant internal surface.
730 refers to an insulant perimeter.
800 refers to a cover.
   810 refers to a cover external surface.
   820 refers to a cover internal surface.
   830 refers to a cover perimeter.
   900 refers to a top.
   910 refers to a top external surface.
   920 refers to a top internal surface.
   930 refers to a top perimeter.

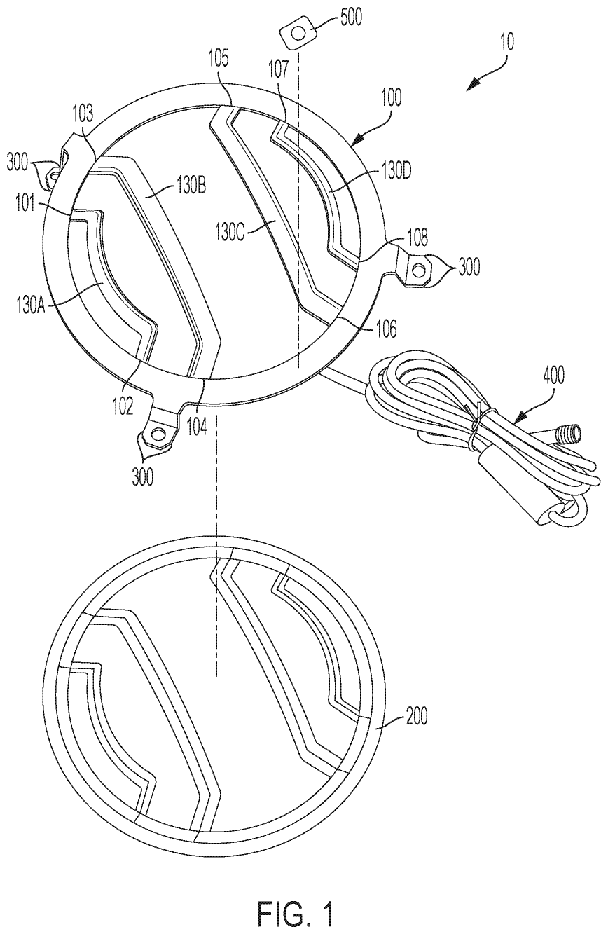

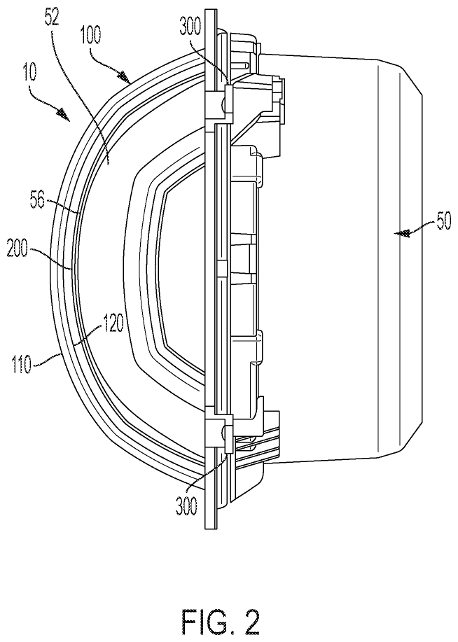

FIG. 1 depicts an exploded perspective view of one embodiment of an apparatus (10) for defrosting a vehicle light ((52) as shown in FIG. 2). As shown in FIG. 1, the apparatus may comprise a frame (100), a heating element (200), at least one mounting bracket (300), and an electrical communication connection (400).

In the embodiment shown in FIG. 1, the frame (100) and the heating element (200) are separate elements connected to one another. The heating element may be connected to an internal facing surface (120) of the frame by any number of different mechanisms including adhesives, fasteners, or by molding the frame around the heating element.

While the embodiment shown in FIG. 1 includes the frame (100) and the heating element (200) as separate elements connected to one another, embodiments may exist in which the frame and the heating element are a single integrated component. That is to say that, in some embodiments, the frame may comprise the heating element. This may be achieved by embedding the heating element in the material of the frame, such as during a casting process. Alternatively, this may be achieved by manufacturing the frame of a material—such as a conductive tube heater material—which is capable of providing radiant heat.

In some embodiments, the apparatus may further comprise a temperature sensor (500), also depicted in FIG. 1. When present, the temperature sensor may be electrically connected to a power source—which may be the vehicle's existing battery or may be a separate power source such as an auxiliary battery. One preferred example of such a temperature sensor is a thermistor. A thermistor is a resistance thermometer, or a resistor whose resistance is dependent on temperature. Certain vehicles are manufactured with an existing temperature sensor (often in the form of an existing thermistor) in which case the vehicle's existing temperature sensor may serve as the temperature sensor for turning the heating element on or off as described herein.

When the temperature sensor determines that temperature conditions exist in which frost, ice, or snow may build up on the vehicle light lens ((54) as shown in FIG. 2), the temperature sensor sends a signal to the vehicle's onboard computer system which in turn sends a signal to the heating element (200) causing the heating element to activate (i.e.—to draw electrical current from a power source and convert that electricity to heat). In some embodiments, the electrical current from the power source may be passed through a relay with the signal from the temperature sensor indicating to the relay when to open and close the circuit between the battery and the heating element. In general, such temperature conditions may include temperatures at the temperature sensor which are at or approaching the freezing point of water (32° F., 0° C.).

FIG. 1 further depicts the frame (100) comprising at least one cross member (130). When present, the cross member(s) may span a distance between any two points on the internal perimeter of the frame. For example, in the embodiment shown in FIG. 1, there are four cross members defined herein as a first cross member (130A), a second cross member (130B), a third cross member (130C), and a fourth cross member (130D). The first cross member spans a distance between a first point (101) on the internal perimeter of the frame and a second point (102) on the internal perimeter of the frame. The second cross member spans a distance between a third point (103) on the internal perimeter of the frame and a fourth point (104) on the internal perimeter of the frame. The third cross member spans a distance between a fifth point (105) on the internal perimeter of the frame and a sixth point (106) on the internal perimeter of the frame. The fourth cross member spans a distance between a seventh point (107) on the internal perimeter of the frame and an eighth point (108) on the internal perimeter of the frame.

The cross member(s) (130), when present, may be connected to the frame (100) by a number of mechanisms. In some embodiments the cross member(s) may be integrally connected to the frame such as by manufacturing the cross member(s) and the frame of a single integral piece of material, or by welding the cross member(s) to the frame. In other embodiments the cross member(s) may be connected to the frame by a fastener such as a screw, a nut, a bolt, a rivet, a clamp, or the like.

In some embodiment where cross member(s) (130) are present, a portion of the heating element (200) may be connected to at least a portion of at least one of the cross member(s). The heating element may be connected to an internal facing surface of the cross member(s) by a number of mechanisms including adhesives, fasteners, or by molding the cross member(s) around the heating element.

While the Figures show the cross member(s) (130) and the heating element (200) connected to one another, embodiments may exist in which the cross member(s) and the heating element are a single integrated component. That is to say that, in some embodiments, the cross member(s) may comprise the heating element. This may be achieved by embedding the heating element into the material of the cross member(s), such as during a casting process. Alternatively, this may be achieved by manufacturing the cross member(s) of a material—such as conductive tube heater material—which is capable of providing radiant heat.

FIG. 2 depicts an assembled side cross section view of one embodiment of an apparatus (10) for defrosting a vehicle light (52). As shown in FIG. 2, the frame (100) of the apparatus will have an external facing surface (110) and an internal facing surface (120). The external and internal facing surfaces refer to the orientation of the frame surfaces relative to the vehicle light. As shown in FIG. 2, once the apparatus has been installed on a vehicle, the external facing surface is oriented in a direction facing away from the vehicle light while the internal facing surface is oriented in a direction facing towards the vehicle light.

Once assembled, the heating element (200) may be connected to at least a portion of the internal facing surface (120) of the frame (100). The heating element may be connected to the internal facing surface of the frame by a number of mechanisms including adhesives, fasteners, or by molding the frame around the heating element. In some embodiments, the heating element may be connected to only a portion of the internal facing surface while in other embodiments the heating element may be connected to substantially all or all of the internal facing surface. Accordingly, it may be said that, when the heating element is connected to the internal facing surface, the heating element covers at least a portion of the surface area of the internal facing surface of the frame. The portion of the surface area of the internal facing surface of the frame which may be covered by the heating element may be in a range selected from the group consisting of between 35% and 100% of the surface area of the internal surface, between 35% and 95% of the surface area of the internal surface, between 35% and 75% of the surface area of the internal surface, between 35% and 50% of the surface area of the internal surface, between 50% and 100% of the surface area of the internal surface, between 50% and 95% of the surface area of the internal surface, between 50% and 75% of the surface area of the internal surface, between 75% and 100% of the surface area of the internal surface, between 75% and 95% of the surface area of the internal surface, and between 95% and 100% of the surface area of the internal surface.

FIG. 2 also shows the at least one mounting bracket (300). As shown in FIG. 2, the at least one mounting bracket is configured to connect between the frame (100) and an exterior surface of a vehicle (50) and/or vehicle light lens (54). The connection between the at least one mounting bracket and the frame may be an integral connection, such as by manufacturing the at least one mounting bracket and the frame as a single integral piece of material or by welding the at least one mounting bracket to the frame. Alternatively, the connection between the at least one mounting bracket and the frame may be a fastened connection in which the at least one mounting bracket is connected to the frame by a fastener such as a screw, bolt, rivet, clamp, or the like. In general, the connection between the at least one mounting bracket and the exterior surface of the vehicle and/or vehicle light lens will be a fastened connection in which the at least one mounting bracket is connected to the exterior surface of the vehicle and/or vehicle light lens by a fastener such as a screw, bolt, rivet, clamp, or the like.

While the examples shown in the Figures include at least one mounting bracket (300), embodiments may exist which do not include a mounting bracket. In such embodiments, the apparatus (10) may include an alternative attachment mechanism which allows the apparatus to be installed on the surface of a vehicle. Alternative attachment mechanisms include—but are not limited to—a plurality of protrusions adapted to provide a friction fit between the frame and a surface of the vehicle, an adhesive applied between a surface of the frame and an external surface of the vehicle, a fastener—such as a screw, a bolt, a rivet, or a clamp-connecting between a surface of the frame and an external surface of the vehicle, a set screw, and combinations thereof.

In some embodiments, once the apparatus (10) is connected to the vehicle, at least a portion of the internal facing surface (120) of the frame (100) and/or the heating element (200) may be in direct contact with at least a portion of the vehicle light lens (54). In other embodiments, once the apparatus is connected to the vehicle, a gap may exist between the internal facing surface of the frame and at least a portion of the vehicle light lens. When present, this gap will have a gap distance measurement (56). As shown in FIG. 2, the gap distance measurement is the minimum distance between a surface of the vehicle light lens and the internal facing surface of the frame. This gap distance measurement may be in a range selected from the group consisting of between 0.1 cm and 12 cm, between 0.1 cm and 10 cm, between 0.1 cm and 5 cm, between 1 cm and 12 cm, between 1 cm and 10 cm, and between 1 cm and 12 cm.

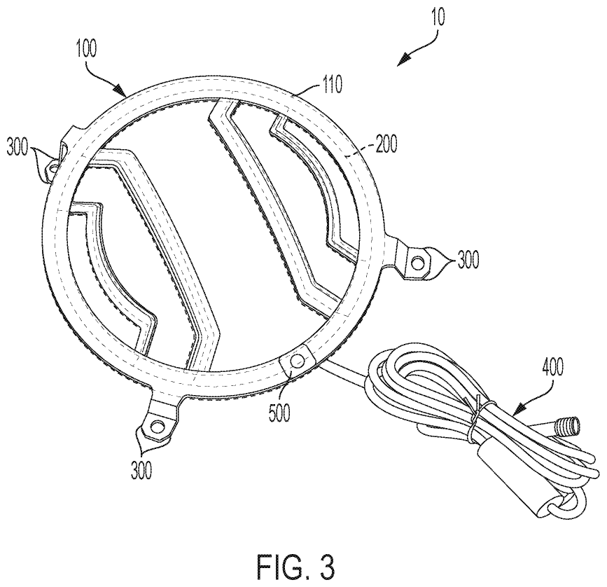

FIG. 3 depicts an assembled perspective view of one embodiment of the apparatus. As shown in FIG. 3, the optional temperature sensor (500) may be connected to at least a portion of the external facing surface (110) of the frame (100). The temperature sensor may be connected to the external facing surface of the frame by a number of mechanisms including adhesives, fasteners, or by molding the frame around the temperature sensor. While FIG. 3 shows the temperature sensor connected to at least a portion of the external facing surface of the frame, one of ordinary skill will recognize that other configurations may exist in which the temperature sensor is connected to other surfaces of the frame—such as the internal facing surface (120 as shown in FIG. 2)—or to the mounting bracket(s) (300). Alternatively, the temperature sensor may be connected external to the frame, such as within the electrical communication connection (400), or at a separate location on the vehicle (such as the vehicles grill) with the temperature sensor electrically connected to the electrical communication connection via a separate wire. When used and when connected to the internal facing surface of the frame, the temperature sensor is preferably connected to a portion of the internal facing surface of the frame which is not connected to the heating element (200).

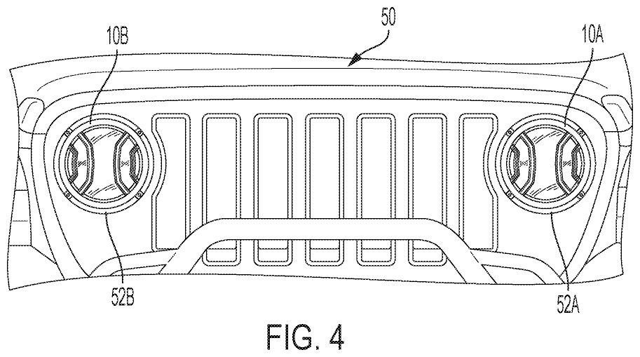

FIG. 4 depicts an embodiment of the apparatus attached to the two headlights of a vehicle (50) with the vehicle's front bumper, grill, headlights, and a portion of the vehicle's hood illustrated. As shown in FIG. 4, a first apparatus (10A) may be connected to the vehicle at the vehicle's left headlight (52A), while a second apparatus (10B) may be connected to the vehicle at the vehicle's right headlight (52B). While FIG. 4 shows the apparatus attached only to the headlights of the vehicle, other embodiments may exist in which different combinations of the vehicles headlight(s), turn signal light(s), daytime running light(s), high beam light(s), tail light(s) and marker light(s) have an embodiment of the apparatus connected thereto.

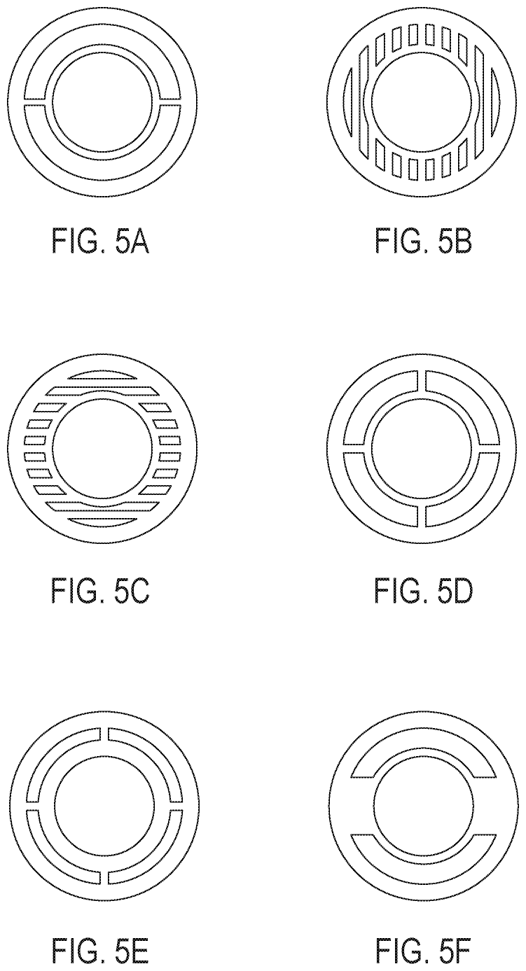

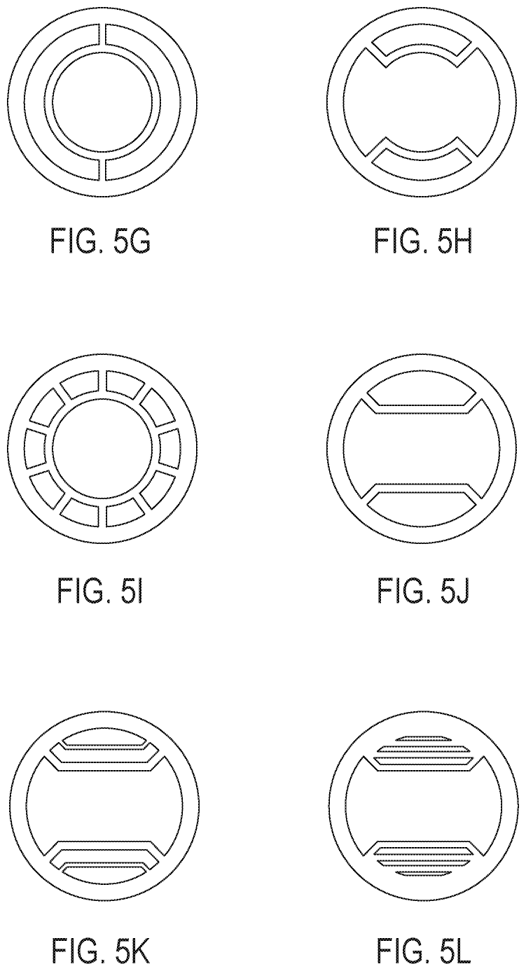

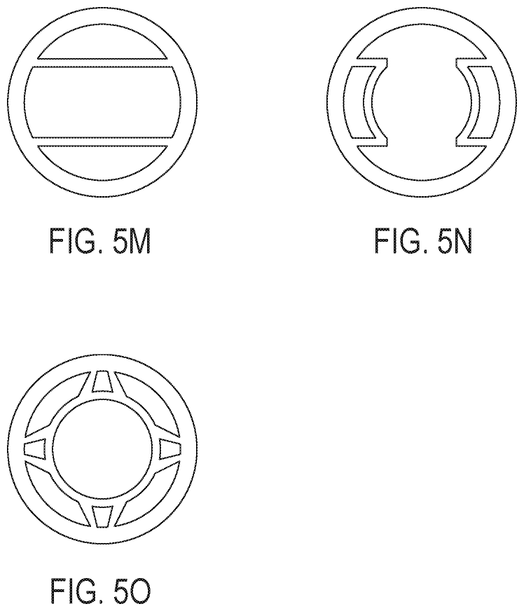

FIG. 5A through FIG. 5O depict front views of various embodiments of cross member(s) (130) connected to various points of the internal perimeter of the frame (100). In some embodiments, such as those shown in FIG. 5A through 5G, FIG. 5I, and FIG. 5O, the apparatus may comprise a pair of cross members which extend from the internal perimeter of the frame and terminate into a circular frame member.

In the apparatus (10) described herein, the heating element (200) may come in a number of forms. One preferred heating element is a ceramic heating element. Other heating elements may include a resistance wire, a conductive heating strip, and a screen-printed conductive silver paste.

In some embodiments, the apparatus (10) may further include a switch. When used, the switch may be located within the vehicle's interior to allow a user to manually turn on and off the heating element (200). When used, the switch allows the vehicle operator to activate the heating element by turning the switch to a switch on position in which a circuit between the vehicle's power system and the heating element is closed. When the circuit is closed, the heating element draws power from the vehicle's power system (i.e.—the vehicle's existing battery or an auxiliary battery) through a wiring connection and converts the electrical current to heat which is generated in the direction of the vehicle's light (52). In some embodiments, the electrical current from the power source may be passed through a relay with the signal from the temperature sensor indicating to the relay when to open and close the circuit between the power source and the heating element. The heat generated by the heating element then serves to melt any ice, snow, or frost on top of or inside the vehicle light lens (54). The vehicle operator may then deactivate the heating element by turning the switch to a switch off position in which the circuit between the vehicle's power system and the heating element is opened. In some embodiments, instead of or in addition to the switch, the circuit may also be closed and opened via an electrical communication connection with the temperature sensor as described herein.

The apparatus (10) disclosed herein allows a vehicle operator to remotely melt any ice, snow, or frost on top of or inside the vehicle light lens (54) by turning the heating element (200) on or off as described herein. Ice, snow, or frost on top of or inside the vehicle light lens can also be melted automatically—i.e., without the need for a user input—by way of the optional temperature sensor which activates the heating element when temperature conditions indicative of ice, snow, or frost are detected at the temperature sensor.

The apparatus (10) disclosed herein also has the advantage of being easy to retrofit to an existing vehicle (50) without the need to replace the entire vehicle light assembly. The apparatus may simply be attached to an external surface of the vehicle and/or vehicle light lens via the mounting bracket(s). The electrical communication connection may then be routed to the vehicle's power system and/or onboard computer system to allow the heating element to be turned on or off as described herein.

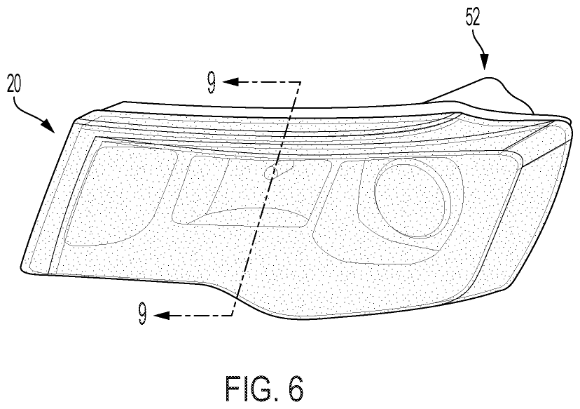

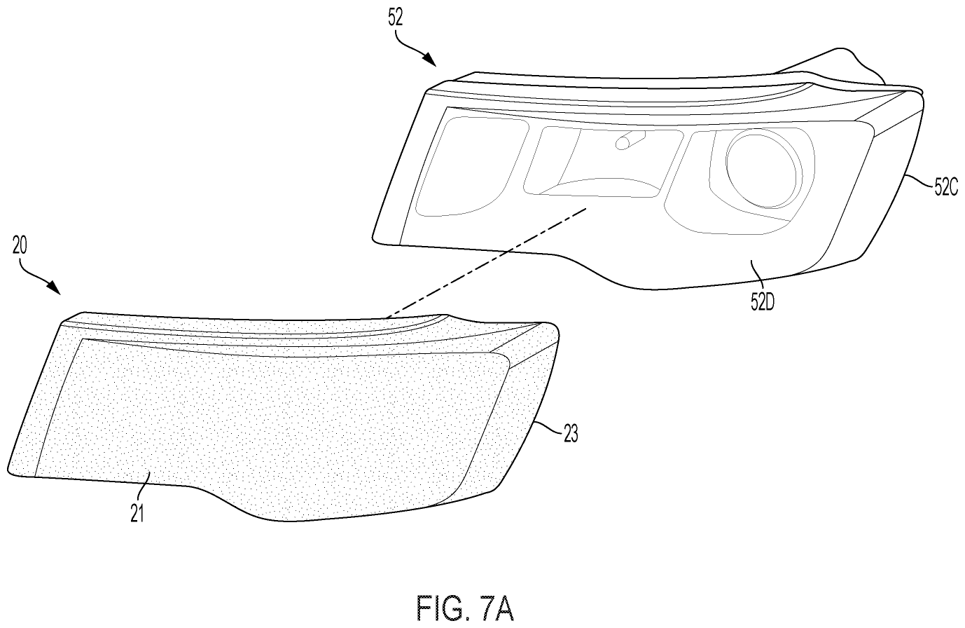

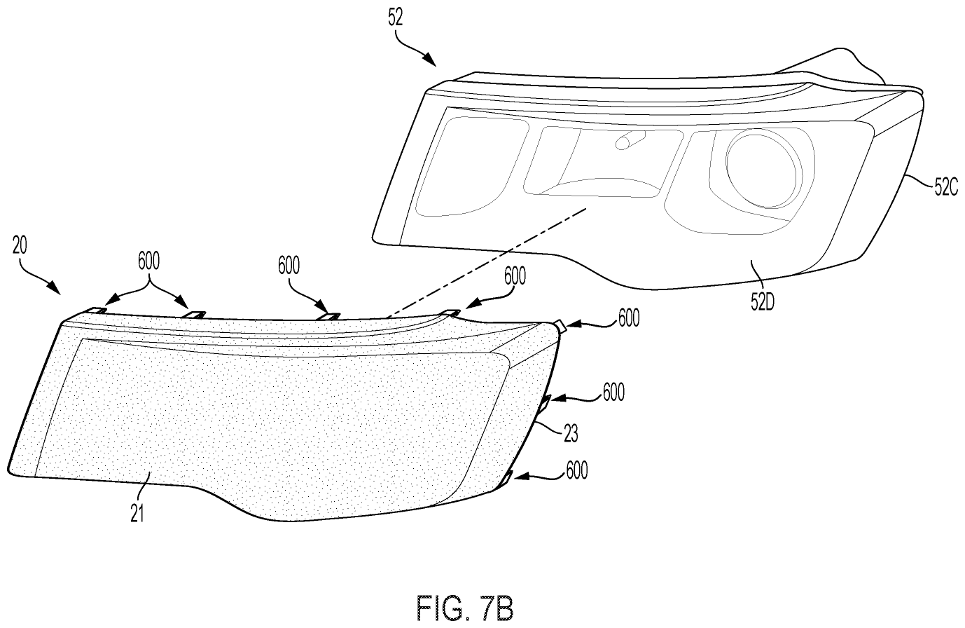

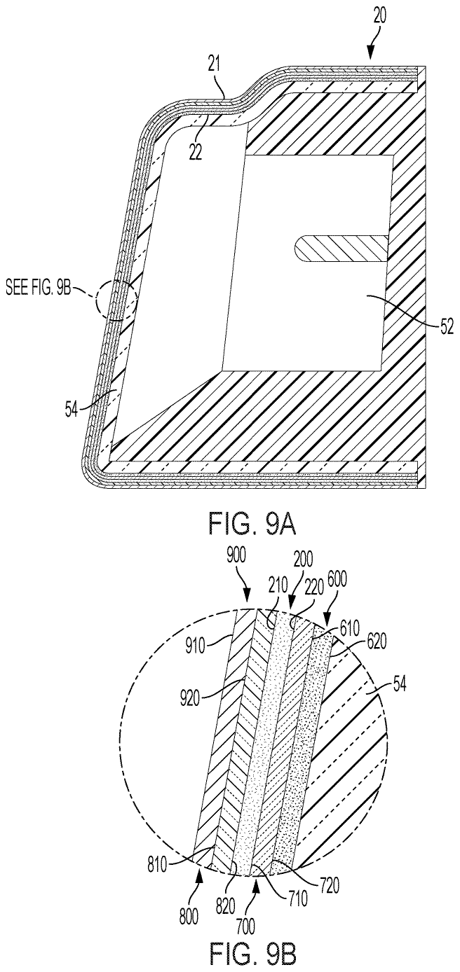

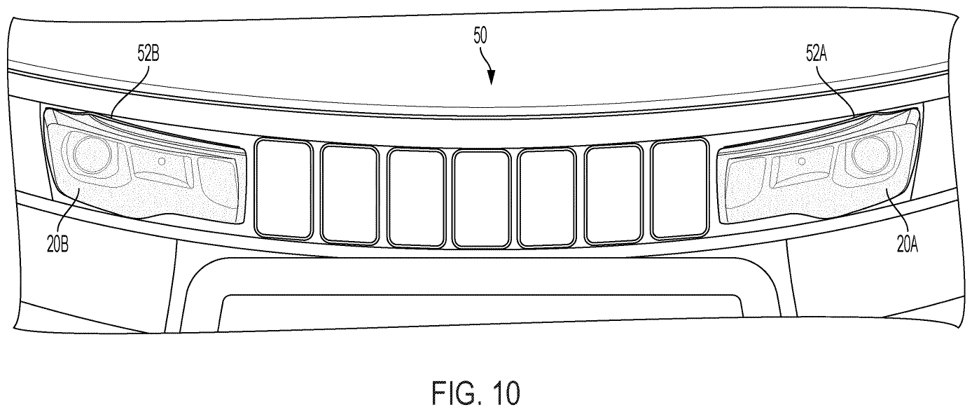

FIG. 6 depicts an assembled perspective view of a layered apparatus (20) for defrosting a vehicle light (52) of a vehicle (50), while FIGS. 7A and 7B depict a view of the layered apparatus exploded from the vehicle light. The layered apparatus includes a layered apparatus external surface (21), a layered apparatus internal surface ((22) as shown in FIG. 9A), and a layered apparatus perimeter (23). The layered apparatus is configured to attach to the vehicle light and/or a vehicle light lens (54). As shown in FIGS. 6 through 7B, the layered apparatus may be in the shape of the contour of a vehicle light lens perimeter (54A). However, the layered apparatus may form any shape within the bounds of a vehicle light lens perimeter.

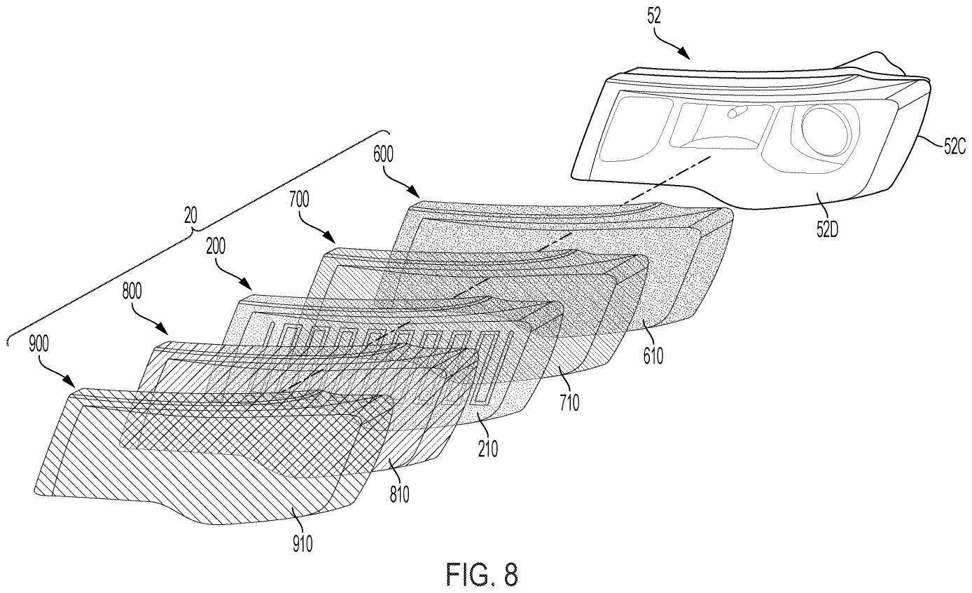

FIG. 8 depicts an exploded view of the layered apparatus (20) exploded from the vehicle light (52). The embodiment of the layered apparatus of FIG. 8 includes an attachment mechanism (600), a heating element (200), a cover (800), and optionally, an insulant (700) and a top (900). The heating element, the cover, and when present, the insulant and the top are coplanar as shown in FIG. 8. The attachment mechanism is configured to attach the insulant, the heating element, the cover, the top, or any combination thereof to the vehicle light and/or the vehicle lens (54).

The insulant (700), when present, includes an insulant external surface (710), an insulant internal surface ((720) as shown in FIG. 9B), and an insulant perimeter (730). The cover (800) includes a cover external surface (810), a cover internal surface ((820) as shown in FIG. 9B), and a cover perimeter (830). The top (900), when present, includes a top external surface (910), a top internal surface ((920) as shown in FIG. 9B), and a top perimeter (930). Additionally, the heating element (200) may include a heating element external surface (210), a heating element internal surface (220), and a heating element perimeter (230).

The embodiment shown in FIG. 8 depicts the attachment mechanism (600) as an adhesive layer having an adhesive layer external surface (610) and an adhesive layer external surface (620). However, the attachment mechanism may be a fastener selected from a group consisting of an adhesive, a bolt, a screw, a rivet, a strap, a nail, a pin, a clip, a snap, and the like. Additionally, the attachment mechanism may be a plurality of clips arranged about the layered apparatus perimeter (23) as shown in the embodiment of FIG. 7B.

As shown in the embodiment of FIG. 8, the adhesive layer perimeter (630), the cover perimeter (830), the heating element perimeter (230), and when present, the insulant perimeter (730) and the top perimeter (930), are preferably configured to match the shape of the vehicle light lens perimeter (54A). However, the adhesive layer perimeter, the insulant perimeter, the cover perimeter, the top perimeter, and/or the heating element perimeter may form a different shape than the vehicle light lens perimeter. Additionally, the adhesive layer perimeter, the insulant perimeter, the cover perimeter, the top perimeter, and the heating element perimeter may each differ from each other.

While the embodiment of FIG. 8 is shown to include an attachment mechanism (600), an insulant (700), a cover (800), and a top (900) with the a heating element (200), not every component needs to be present along with the heating element in the layered apparatus (20). For example, the layered apparatus could still function including only the attachment mechanism with the heating element. Another example of a functional layered apparatus includes the attachment mechanism, the heating element, and the cover. However, any combination of the components may be present along with the heating element for the layered apparatus to function.

FIG. 9A depicts a cross-section view of the layered apparatus (20) for defrosting a vehicle light assembled on a vehicle light (52), while FIG. 9B shows a close up view of the cross-section of the layered apparatus. FIGS. 9A and 9B shown the attachment mechanism (600) as an adhesive layer. As shown in FIGS. 9A and 9B, the adhesive layer internal surface (620) is configured to attach to the vehicle light lens (54). Additionally, the adhesive layer external surface (610) may be configured to attach to the insulant internal surface (720), the insulant external surface (710) may be configured to attach to the heating element internal surface (220), the heating element external surface (210) may be configured to attach to the cover internal surface (820), and the cover external surface (810) may be configured to attach to the top internal surface (920).

While the embodiment of FIGS. 9A and 9B depict the above mentioned configuration, the adhesive layer external surface (610) may be configured to attach to the heating element internal surface (220) or the cover internal surface (820). The insulant external surface (710) may be configured to attach to the cover internal surface (820), or the top internal surface (920). The cover external surface may be configured to attach to the insulant internal surface (720). While the preceding examples list other possible embodiments of the layered apparatus (20), the components may be configured in any order and combination thereof.

FIG. 10 depicts an embodiment of the layered apparatus (20) attached to the two vehicle lights (52A and 52B) of a vehicle (50) with the vehicle's front bumper, grill, headlights, and a portion of the vehicle's hood illustrated. As shown in FIG. 10, a first layered apparatus (20A) may be connected to the vehicle at the vehicle's left headlight (52A), while a second layered apparatus (20B) may be connected to the vehicle at the vehicle's right headlight (52B). While FIG. 10 shows the layered apparatus attached only to the vehicle lights of the vehicle, other embodiments may exist in which different combinations of the vehicles light(s), turn signal light(s), daytime running light(s), high beam light(s), tail light(s) and marker light(s) have an embodiment of the apparatus connected thereto.

In some embodiments, the attachment mechanism (600), insulant (700), cover (800), top (900), or any combination thereof, may be permanently attached to each other. This may be achieved by permanently adhering, embedding, or integrating to each other to form the layered apparatus (20) around the heating element (200). Permanently adhering means to hold fast permanently by an adhesive. An adhesive may be selected from a group consisting of a pressure-sensitive adhesive, an optical-grade adhesive, a thermally conductive adhesive, a permanent adhesive, a repositionable adhesive, and any combination thereof. Embedding means to fix firmly and deeply in a surrounding mass. For example, the heating element (200) may be embedded into the cover (800) by fixing the heating element within the cover internal surface (820) so that the heating element perimeter (230) is totally surrounded by the cover internal surface. Likewise, the attachment mechanism may be embedded into the cover internal surface or near the cover perimeter (830). Integrating means to make several individual parts into one whole part. This may be done by additive manufacturing, injection molding, welding, casting, and the like. For example, the attachment mechanism, the insulant, the heating element, the cover, and the top may be additively manufactured as one continuous layered apparatus.

In some embodiments, the attachment mechanism (600), insulant (700), cover (800), top (900), or any combination thereof, may be removably attached to each other. This may be achieved by mechanical fastening or removably adhering to each other to form the layered apparatus (20) around the heating element. Mechanical fastening may be achieved by a bolt, a screw, a rivet, a strap, a nail, a pin, a clip, a snap, and any combination thereof. Removably adhering means to hold fast removably by an adhesive. An adhesive may be selected from a group consisting of a pressure-sensitive adhesive, an optical-grade adhesive, a thermally conductive adhesive, a removeable adhesive, a repositionable adhesive, and any combination thereof.

When the attachment mechanism (600) is an adhesive layer, the adhesive layer may comprise an adhesive selected from a group consisting of a pressure-sensitive adhesive, an optical-grade adhesive, a thermally conductive adhesive, a removeable adhesive, a permanent adhesive, a repositionable adhesive, and any combination thereof.

Alternatively, the attachment mechanism (600) may be a fastener selected from a group consisting of an adhesive, a bolt, a screw, a rivet, a strap, a nail, a pin, a clip, and a snap. Additionally, the attachment mechanism may be a plurality of clips arranged about a layered apparatus perimeter (23) as shown in the embodiment of FIG. 7B.

In some embodiments, the layered apparatus may further comprise a temperature sensor ((500) as shown in FIG. 1). When present, the temperature sensor may be electrically connected to a power source—which may be the vehicle's existing battery or may be a separate power source such as an auxiliary battery. One preferred example of such a temperature sensor is a thermistor. A thermistor is a resistance thermometer, or a resistor whose resistance is dependent on temperature. Certain vehicles are manufactured with an existing temperature sensor (often in the form of an existing thermistor) in which case the vehicle's existing temperature sensor may serve as the temperature sensor for turning the heating element on or off as described herein.

When the temperature sensor determines that temperature conditions exist in which frost, ice, or snow may build up on the vehicle light lens (54), the temperature sensor sends a signal to the vehicle's onboard computer system which in turn sends a signal to the heating element (200) causing the heating element to activate (i.e.—to draw electrical current from a power source and convert that electricity to heat). In some embodiments, the electrical current from the power source may be passed through a relay with the signal from the temperature sensor indicating to the relay when to open and close the circuit between the battery and the heating element. In general, such temperature conditions may include temperatures at the temperature sensor which are at or approaching the freezing point of water (32° F., 0° C.).

In the layered apparatus (20) described herein, the heating element (200) may come in a number of forms. One preferred heating element is conductive mesh heating element. Other heating elements may include a resistance wire, a conductive heating strip, a screen-printed conductive silver paste, a fine metal grid, a printed conductive ink, a plurality of silver nanowires, a graphene, a carbon-based material, a conductive coating, a conductive polymer, a vapor-deposited metal, a sputtered metal, a plurality of etched conductive traces, a thin resistive wire pattern, and any combination thereof.

The attachment mechanism (600), insulant (700), cover (800), and top (900) may each be made of a material selected from a group consisting of a polymer, a ceramic, a composite, a film, and any combination thereof. The material of the attachment mechanism, insulant, cover, and the top may vary from each other or be the same.

The attachment mechanism (600), insulant (700), heating element (200), cover (800), and top (900) may be any thickness. However, the thickness of the attachment mechanism, insulant, heating element, cover, and top are each individually preferably a thickness in the range of 0.1 mm to 5 mm. The thickness of the attachment mechanism, insulant, heating element, cover, and top may each be the same, or they may vary from each other.

In some embodiments, the layered apparatus (20) may have a combined light transmission of at least 70%. Light transmission is the amount of light which can successfully pass through a material. For example, a light transmission of at least 70% means that 70% of the light originating from one side of the layered apparatus may pass through and be emitted beyond the opposing side of the layered apparatus. The combined light transmission of the layered apparatus refers to the light transmission which may result from the combination of light transmissions from the attachment mechanism (600), insulant (700), heating element (200), cover (800), and top (900). In other embodiments, the layered apparatus may have a combined light transmission of at least 70%, 80%, or 90%.

Additionally, the attachment mechanism (600) itself may have a light transmission of at least 70%, 80%, or 90%. The insulant (700) itself may have a light transmission of at least 70%, 80%, or 90%. The heating element (200) itself may have a light transmission of at least 70%, 80%, or 90%. The cover (800) itself may have a light transmission of at least 70%, 80%, or 90%. The top (900) itself may have a light transmission of at least 70%, 80%, or 90%. However, the combination of the light transmission of the attachment mechanism, insulant, heating element, cover, and top, should not result in the light transmission of the layered apparatus drop below 70% for safety reasons. While the light transmission of the attachment mechanism, insulant, heating element, cover, and top are preferably the same, the light transmission of each may vary.

In some embodiment of the layered apparatus (20), the heating element (200) may heat the vehicle light (52) by resistive heating, self-regulating heat, radiant heating, infrared heating, induction-based heating, direct conduction, indirect heating, or any combination thereof.

In some embodiments, the layered apparatus (20) may further include a switch. When used, the switch may be located within the vehicle's interior to allow a user to manually turn on and off the heating element (200). When used, the switch allows the vehicle operator to activate the heating element by turning the switch to a switch on position in which a circuit between the vehicle's power system and the heating element is closed. When the circuit is closed, the heating element draws power from the vehicle's power system (i.e.—the vehicle's existing battery or an auxiliary battery) through a wiring connection and converts the electrical current to heat which is generated in the direction of the vehicle's light (52). In some embodiments, the electrical current from the power source may be passed through a relay with the signal from the temperature sensor indicating to the relay when to open and close the circuit between the power source and the heating element. The heat generated by the heating element then serves to melt any ice, snow, or frost on top of or inside the vehicle light lens (54). The vehicle operator may then deactivate the heating element by turning the switch to a switch off position in which the circuit between the vehicle's power system and the heating element is opened. In some embodiments, instead of or in addition to the switch, the circuit may also be closed and opened via an electrical communication connection with the temperature sensor as described herein.

The layered apparatus (20) disclosed herein allows a vehicle operator to remotely melt any ice, snow, or frost on top of or inside the vehicle light lens (54) by turning the heating element on or off as described herein. Ice, snow, or frost on top of or inside the vehicle light lens can also be melted automatically—i.e., without the need for a user input—by way of the optional temperature sensor which activates the heating element when temperature conditions indicative of ice, snow, or frost are detected at the temperature sensor.

The layered apparatus (20) disclosed herein also has the advantage of being easy to retrofit to an existing vehicle (50) without the need to replace the entire vehicle light assembly. The layered apparatus may simply be attached to an external surface of the vehicle and/or vehicle light lens via the attachment mechanism. The electrical communication connection may then be routed to the vehicle's power system and/or onboard computer system to allow the heating element to be turned on or off as described herein.

What is claimed is:

1. A layered apparatus (20) for defrosting a vehicle light (52) comprising:
a heating element (200) having a heating element external surface (210) and a heating element internal surface (220);
a cover (800) having a cover external surface (810) and a cover internal surface (820); and
an attachment mechanism (600);
wherein the heating element and the cover are coplanar; and
the attachment mechanism is configured to attach the heating element and the cover to the vehicle light (52).

2. The layered apparatus of claim 1, further comprising an insulant (700) having an insulant external surface (710) and an insulant internal surface (720), wherein the insulant is coplanar with the heating element, and the cover.

3. The layered apparatus of claim 1, further comprising a top (900) having a top external surface (910) and a top internal surface (920), wherein the top is coplanar with the heating element, and the cover.

4. The layered apparatus of claim 2, further comprising a top having a top external surface and a top internal surface, wherein the top is coplanar with the heating element, the cover, and the insulant.

5. The layered apparatus of claim 1, wherein the heating element internal surface is attached to the attachment mechanism and the heating element external surface is attached to the cover internal surface.

6. The layered apparatus of claim 2, wherein the insulant internal surface is attached to the attachment mechanism, the insulant external surface is attached to the heating element internal surface, and the heating element external surface is attached to the cover internal surface.

7. The layered apparatus of claim 3, wherein the heating element internal surface is attached to the attachment mechanism, the heating element external surface is attached to the cover internal surface, and the cover external surface is attached to the top internal surface.

8. The layered apparatus of claim 4, wherein the insulant internal surface is attached to the attachment mechanism, the insulant external surface is attached to the heating element internal surface, the heating element external surface is attached to the cover internal surface, and the cover external surface is attach to the top internal surface.

9. The layered apparatus of claim 1, wherein the heating element is attached to the cover by an attachment method selected from a group consisting of adhering, mechanical fastening, embedding, and integrating.

10. The layered apparatus of claim 6, wherein the heating element external surface is attached to the cover internal surface and the insulant external surface is attached to the heating element internal surface each by an attachment method selected from a group consisting of adhering, mechanical fastening, embedding.

11. The layered apparatus of claim 7, wherein the heating element external surface is attached to the cover internal surface and the top internal surface is attached to the cover external surface each by an attachment method selected from a group consisting of adhering, mechanical fastening, embedding.

12. The layered apparatus of claim 8, wherein the heating element external surface is attached to the cover internal surface, and the insulant external surface is attached to the heating element internal surface, and the top internal surface is attached to the cover external surface each by an attachment method selected from a group consisting of adhering, mechanical fastening, embedding.

13. The layered apparatus of claim 1, wherein the attachment mechanism comprises an adhesive layer having an adhesive layer external surface (610) and an adhesive layer internal surface (620), wherein the adhesive layer internal surface is configured to adhere to a vehicle lens (54) of the vehicle light.

14. The layered apparatus of claim 1, wherein the attachment mechanism comprises a fastener selected from a group consisting of an adhesive, a bolt, a screw, a rivet, a strap, a nail, a pin, a clip, and a snap.

15. The layered apparatus of claim 1, wherein the attachment mechanism comprises a plurality of clips arranged about an layered apparatus perimeter (23).

16. The layered apparatus of claim 1, wherein the attachment mechanism has a light transmission of at least 70%.

17. The layered apparatus of claim 1, wherein the heating element has a light transmission of at least 70%.

18. The layered apparatus of claim 1, wherein the cover has a light transmission of at least 70%.

19. The layered apparatus of claim 1, wherein the heating element is selected from a group consisting of a conductive mesh, a fine metal grid, a printed conductive ink, a plurality of silver nanowires, a graphene, a carbon-based material, a conductive coating, a conductive polymer, a vapor-deposited metal, a sputtered metal, a plurality of etched conductive traces, a thin resistive wire pattern, and any combination thereof.

20. The layered apparatus of claim 13, wherein the adhesive layer comprises an adhesive selected from a group consisting of a pressure-sensitive adhesive, an optical-grade adhesive, a thermally conductive adhesive, a removeable adhesive, a permanent adhesive, a repositionable adhesive, and any combination thereof.
